(19) United States
(12) Patent Application Publication
(10) Pub. No.: US 2009/0206559 A1
(43) Pub. Date: Aug. 20, 2009

(54) Eccentric collet chuck for CNC lathe adjustment the concentricity and misalignment

(76) Inventor: Bill Nguyen, Carson, CA (US)

Correspondence Address: BILL NGUYEN, 16536 SAN PEDRO ST., CARSON, CA, 90746, US

(21) Appl. No.: 12/069,919

(22) Filed: Feb. 14, 2008

(51) Int. Cl. B23B 5/34

(52) U.S. Cl. 279/6

(57) ABSTRACT

An eccentric collet chuck comprising: a clamp hexagons nut and a body shank having inner conical surface axis eccentric with outer body shank surface axis and rotate able within the stationary tool holder mounting socket, the eccentric collet chuck is design for easy adjustment of concentricity and misalignment between spindle axis of a lathe and turret tool holder axis.

### BACKGROUND OF THE INVENTION

This present invention relates to collet chuck tool holder for CNC lathe machines and more practical for adjustment of concentricity and misalignment between spindle axis of a lathe and collet chuck turret tool holder axis. The precise concentric of the spindle axis and the cutting-tool turret tool holder axis is known to be necessary In order to increase cutting tools life of center drill, drilling, reaming, countersink, end mill, it's unique designed allow easy adjustment of concentricity and misalignment between spindles axes of a lathe and collet chuck turret tool holder axis by rotation of the eccentric collet chuck within the stationary tool holder mounting socket, the effective eccentric of the conical surface axis relative to the body outer shank surface axis, providing for the high precision concentricity adjustment required.

### SUMMARY OF THE INVENTION

This is an improved collet chuck, the present invention Eccentric collet chuck is to provide an easy adjustment of concentricity and misalignment between spindle axis of a CNC lathe machine and collet chuck turret tool holder axis comprises: a clamp hexagons nut and a body shank having inner conical surface axis is eccentric with outer body shank axis and rotate able within the stationary turret tool holder mounting socket, which helpful the machinist easy adjustment the precise concentricity between spindles axes of a lathe machine and the cutting-tool axis, by rotate the eccentric collet chuck within the stationary turret tool holder mounting socket.

### BRIEF DESCRIPTION OF THE DRAWINGS

FIG. 1 is an Isometric view of eccentric collet chuck 22, and a clamp hexagons nut 5

FIG. 2 schematically illustrates eccentric collet chuck 22, installed within the turret tool holder mounting socket, showing spindle axis of a lathe center line 10, and the center line 9, of a center drill 8, is out of concentricity.

FIG. 3 is a view similar to FIG. 2, but the testing dial indicator 20 is showing center line 10, and the center line 9, is concentric and alignment together.

FIG. 4 is enlarged elevation and cross-sectional view of turret tool holder 17, eccentric collet chuck 22, and a center drill 8.

### DETAILED DESCRIPTION OF THE INVENTION

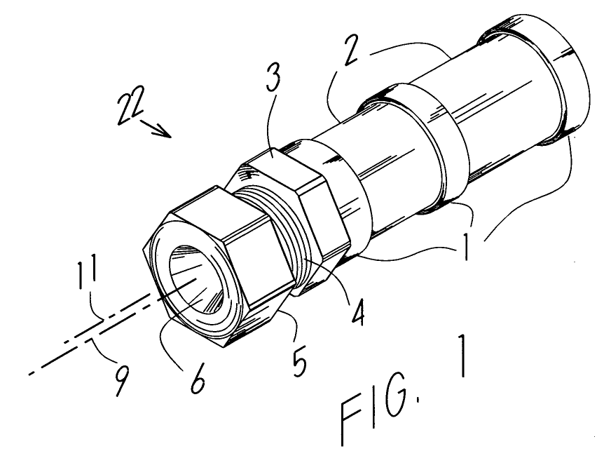

As shown in. FIG. 1 schematically illustrates an eccentric collet chuck 22, for use on CNC lathe, such as for mounting socket upon the turret tool holder of the CNC lathe machines. The eccentric collet chuck comprises: a clamp hexagons nut 5, having tapered bore 25, a single moon crescent flange 23, fit into the annular groove 24, of the spring collet 7, and the right hand internal threaded 26, when the clamp hexagons nut is turning counter clock-wise removing form the main body chuck, then the single moon crescent flange 23, is used to pull out the spring collet 7, from the inner conical surface 6. A main body outer shank surface 1 having center-line axis 11, the inner conical surface 6 having axis 9, and the axis 9, is eccentric to the center-line axis 11, the annular under-cut grooved 2; hexagons collar 3, the external thread 4, internal threaded 15.

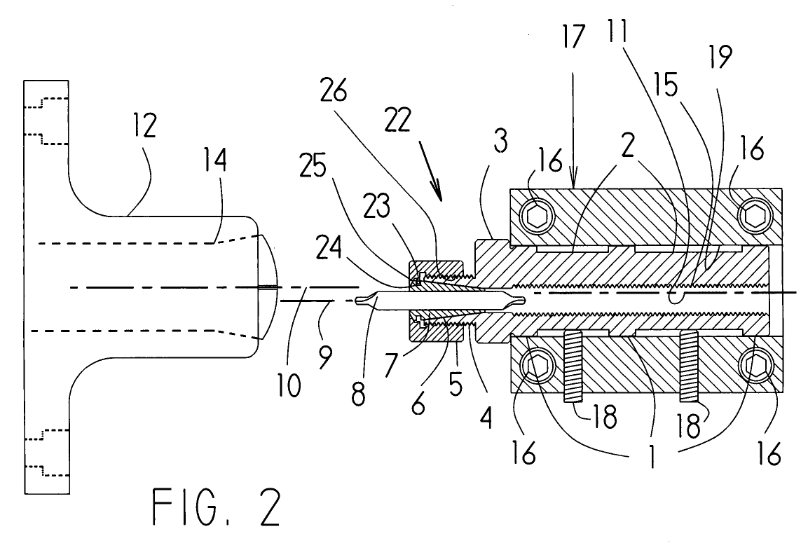

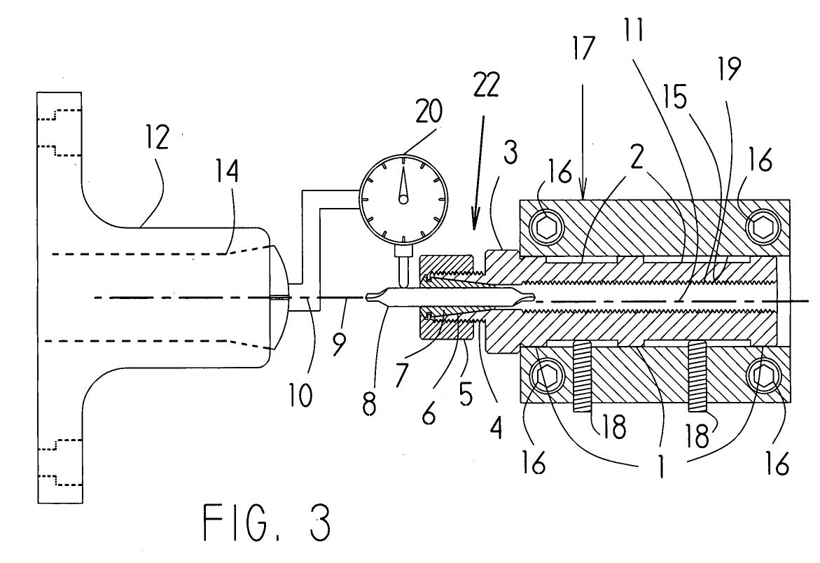

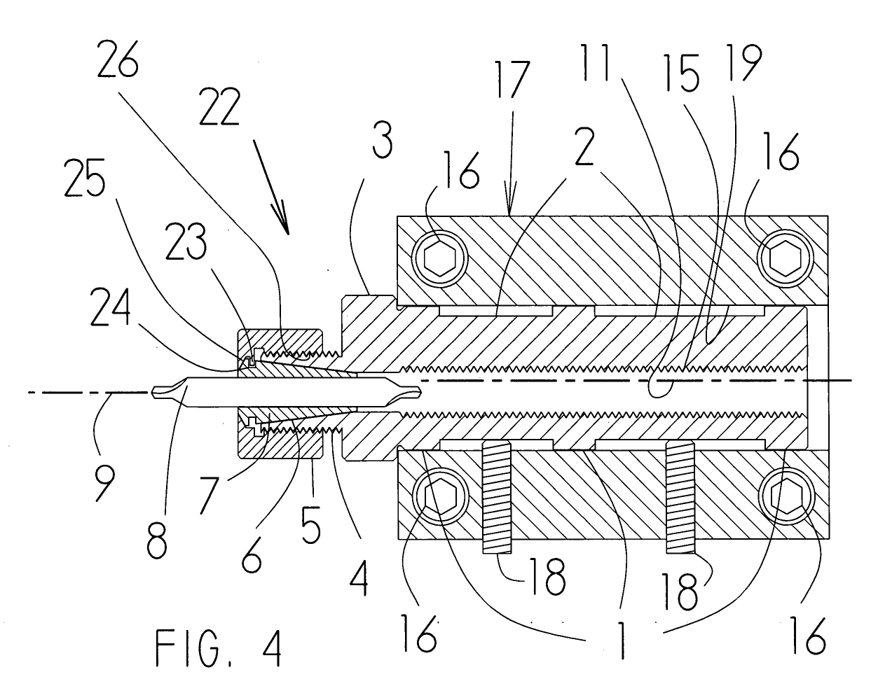

FIG. 2 to FIG. 4, after the eccentric collet chuck 22 has been installed in the turret tool holder 17 mounting socket 19, under cut annular grooved 2 where the cup point set screws 18 force down for tightly grip the eccentric collet chuck within the turret tool holder mounting socket 19, a spring collet 7, center-drill 8, the center line spindle axis 10, of a lathe, conventional collet 14, a collet closer 12, fastens bolts 16. For the precision concentricity adjustment between the spindle axes 10, of a lathe and the collet chuck axis 9, after the eccentric collet chuck 22 has been installed in the turret tool holder 17, mounting socket 19, by placing the test dial indicator 20, in to the conventional collet chucks 14. FIG. 3 as shown, by rotating the eccentric collet chuck 22 while rotating the test dial indicator 20, around the center-drill shank 8, by rotating the collet closer 12, and shifting the X axis of the CNC lathe machine until the pointer of the test dial indicator 20 will remain within 0 to 0.0004 of an inch.

What is claimed is:

1. An eccentric collet chuck for CNC lathe adjustment of Concentricity and misalignment between spindle axes of a lathe axis and cutting tool holder axis comprising:
1. A clamp hexagons nut having right hand internal threaded, a single moon crescent flange with a through tapered bore at one end.
2. A collet chuck having outer body longitudes surface axis and an inner conical surface axis is eccentric to the outer body longitudes surface axis, an external and internal threaded, collar hexagons, longitudinal outer body shank having two under-cut annular grooved.
